(19) United States
(12) Patent Application Publication
(10) Pub. No.: US 2018/0360042 A1
(43) Pub. Date: Dec. 20, 2018

(54) Liquid fungicide-containing formulations

(71) Applicant: BAYER CROPSCIENCE AKTIENGESELLSCHAFT, Monheim am Rhein (DE)

(72) Inventors: Martin WEIß, Bornheim/Sechtem (DE); Martin STEINBECK, Köln (DE); Friedhelm SCHULTZ, Oberhausen (DE)

(73) Assignee: Bayer CropScience Aktiengesellschaft, Monheim am Rhein (DE)

(21) Appl. No.: 16/060,066

(22) PCT Filed: Dec. 8, 2016
(86) PCT No.: PCT/EP2016/080215

§ 371 Date: Jun. 7, 2018

(30) Foreign Application Priority Data
Dec. 11, 2015 (EP) 15199491.0

(51) Int. Cl. A01N 43/653; A01N 25/04; A01N 25/22

(52) U.S. Cl. CPC A01N 43/653; A01N 25/22; A01N 25/04

(57) ABSTRACT

The invention relates to stabilized liquid fungicide-containing formulations based on fatty acid amides as solvents, to a process for production thereof, to a method of controlling phytopathogenic fungi in crop protection, and to the use thereof as crop protection agents.

The invention relates to stabilized liquid fungicide-containing formulations based on fatty acid amides as solvents, to a process for production thereof, to a method of controlling phytopathogenic fungi in crop protection, and to the use thereof as crop protection agents.

It is already known that prothioconazole can be used in standard formulations for control of fungi (WO-A 96/16 048). This active ingredient is 2-[2-(1-chlorocyclopropyl)-3-(2-chlorophenyl)-2-hydroxypropyl]-2,4-dihydro-3H-1,2,4-triazole-3-thione. Prothioconazole-containing formulations are liquid formulations and are supplied on the market, for example, in the form of emulsion concentrates.

It is known that the active ingredient prothioconazole can be degraded under particular conditions to give the compound 2-(1-chlorocyclopropyl)-1-(2-chlorophenyl)-3-(1H-1,2,4-triazol-1-yl)propan-2-ol (PSM-Zulassungsbericht [Crop Protection Agent Registration Report], Tilmor, 2010 Aug. 30, serial no. 21, German Federal Office of Consumer Protection and Food Safety).

Therefore, prothioconazole-containing formulations, as early as in the course of production, may contain a certain amount of 2-(1-chlorocyclopropyl)-1-(2-chlorophenyl)-3-(1H-1,2,4-triazol-1-yl)propan-2-ol. In the case of storage under severe conditions, such as elevated temperatures, incidence of light and oxygen contact, it is likewise possible for degradation of prothioconazole to take place to give 2-(1-chlorocyclopropyl)-1-(2-chlorophenyl)-3-(1H-1,2,4-triazol-1-yl)propan-2-ol, as a result of which the proportion of active ingredient in the formulations is correspondingly reduced. Since the compound 2-(1-chlorocyclopropyl)-1-(2-chlorophenyl)-3-(1H-1,2,4-triazol-1-yl)propan-2-ol is a relevant impurity, the content thereof in prothioconazole-containing formulations is subject to regulatory limitation.

WO-A 2012/033590 discloses aqueous dispersions of prothioconazole containing a sulphur compound, for example L-cysteine. The formulations described therein exhibit improved stability, but they are not emulsion concentrates. However, the concepts disclosed in WO-A 2012/033590 cannot be applied to emulsion concentrates.

There was therefore still a need for stable prothioconazole-containing emulsion concentrates, which, even over a long period and under relatively severe storage conditions, for example oxygen contact, high temperatures or incidence of light, do not include any significant amounts of degradation products, especially of 2-(1-chlorocyclopropyl)-1-(2-chlorophenyl)-3-(1H-1,2,4-triazol-1-yl)propan-2-ol.

It was thus an object of the invention to provide novel, improved prothioconazole-containing formulations which have high storage stability and do not exhibit any significant degradation rates of prothioconazole to give 2-(1-chlorocyclopropyl)-1-(2-chlorophenyl)-3-(1H-1,2,4-triazol-1-yl)propan-2-ol.

The present invention therefore provides liquid formulations comprising
a) prothioconazole and
b) at least one organic solvent, characterized in that one organic solvent is a compound of the formula (I)

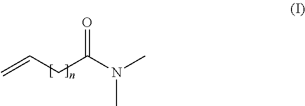

in which
n is 3, 4, 5, 6, 7, 8, 9, 10, 11, 12, 15 or 18.

The formulation of the invention is a liquid formulation. These formulations include the following formulation types: DC (GCPF formulation code for dispersible concentrate); EC (GCPF formulation code for emulsion concentrate); EW (GCPF formulation code for oil-in-water emulsion); ES (GCPF formulation code for emulsion for seed treatment), FS (GCPF formulation code for multiphase concentrate for seed treatment), EO (GCPF formulation code for water-in-oil emulsion; ME (GCPF formulation code for microemulsion; SE (GCPF formulation code for suspoemulsion); SL (GCPF formulation code for water-soluble concentrate); CS (GCPF formulation code for capsule suspension) and AL (GCPF formulation code for ready-to-use liquid formulation, other liquids for undiluted application).

Particular preference is given to emulsion concentrates (EC formulation type). An emulsion concentrate is typically understood to mean a composition that forms an oil-in-water emulsion when mixed with water. The emulsion is typically formed spontaneously. The concentrate preferably takes the form of a homogeneous solution. It is typically virtually free of dispersed particles.

More particularly, the formulations of the invention provide stable emulsion concentrate formulations of prothioconazole, optionally in combination with further organic, water-insoluble active ingredients, preferably selected from fungicides and insecticides, for treatment of plants.

The present invention further provides for the use of the formulations of the invention for treatment of plants and corresponding methods.

Prothioconazole (with the chemical name 2-[2-(1-chlorocyclopropyl)-3-(2-chlorophenyl)-2-hydroxypropyl]-1,2-dihydro-3H-1,2,4-triazole-3-thione) (CAS number 178928-70-6) takes the form of a racemate. Suitable processes for preparation thereof are described in DE-A 195280. Prothioconazole may be present in the thiono form of the general formula (II)

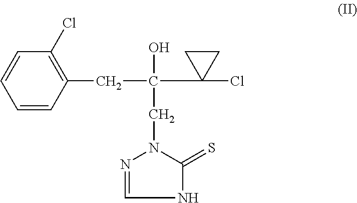

or in the tautomeric mercapto form of the general formula (IIa)

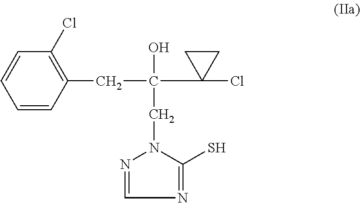

The use of the term “prothioconazole” hereinafter always covers both isomers and both tautomers. 2-(1-Chlorocyclopropyl)-1-(2-chlorophenyl)-3-(1H-1,2,4-triazol-1-yl)propan-2-ol likewise takes the form of a racemate and has the general formula (III)

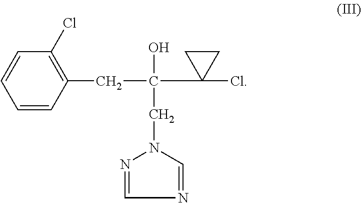

The proportion of component a) (prothioconazole) in the formulations of the invention may be 1% by weight to 40% by weight, preferably 4% by weight to 30% by weight, more preferably 5 by weight to 28 by weight.

The formulations of the invention comprise, as solvent b), at least one solvent of the compound (I). Preference is given to compounds (I) in which n is 7, 8 or 9, more preferably 7 or 8 and most preferably 7.

Very particular preference is given to the compound (I) (N,N-dimethyl 9-decenamide, CAS number: 1356964-77-6). The compound is available under the Hallcomid® 1025 or Steposol® MET-10U trade name from Stepan, USA. Compounds of the formula (I) can be prepared via the method of metathesis (WO-A 2012/061094).

Further suitable organic solvents b) are
aromatic hydrocarbon mixtures (preferably naphthaline reduced), for example Solvesso®;
aromatic hydrocarbons, for example white spirit, petroleum, alkylbenzenes and spindle oil, xylene, toluene or alkylnaphthalenes;
aliphatic/cycloaliphatic hydrocarbons, for example mineral oils, hexane, heptane, octane, nonane, decane, cyclopentane, cyclohexane, decalin or white oil;
chlorinated aromatic or aliphatic hydrocarbons, for example chlorobenzene, chloroethylene, or methylene chloride, chloroform or tetrachloromethanes;
alcohols, for example methanol, ethanol, isopropanol, butanol, ethylene glycol, propylene glycol or benzyl alcohol;
ethers, for example tetrahydrofuran, tetrahydrofurfuryl alcohol, tetrahydropyran, 1,4-dioxanes, diethyl ether, methyl tert-butyl ether, dihexyl ether, dioctyl ether, didecyl ether, dibenzyl ether, dimethylisosorbide, diphenyl ether, ethyl phenyl ether, phenyl benzyl ether or anisole;
monoesters/diesters/glycerol esters, for example ethyl acetate, butyl propionate, pentyl propionate, benzyl acetate, benzyl benzoate, butyl benzoate, Rhodiasolv® Polarclean, Rhodiasolv® RPDE, methyl lactate, ethyl lactate, propyl lactate, butyl lactate, 2-ethylhexyl lactate, ethyl 3-ethoxypropionate (UCAR® Ester EEP, Dow Chemical Company), dimethyl succinate, diethyl succinate, dipropyl succinate, dimethyl adipate, diethyl adipate, dipropyl adipate, dimethyl glutarate, diethyl glutarate, dipropyl glutarate, bis(2-ethylhexyl) adipate, diisopropyl adipate, dimethyl 2-methylglutarate, dioctyl maleate, glycerol monoacetate, glycerol diacetate, glycerol triacetate, vegetable oils, for example rapeseed oil, sunflower oil, soya oil, castor oil or corn oil;
lactones, for example butyrolactone, alpha-methyl-gamma-butyrolactone, gamma-valerolactone or delta-valerolactone;
polyethylene/propylene oxides, for example monoethylene glycol, monoethylene glycol monomethyl ether, monoethylene glycol monoethyl ether, monoethylene glycol monopropyl ether, monoethylene glycol monobutyl ether, monoethylene glycol monopentyl ether, monoethylene glycol monohexyl ether, monoethylene glycol monophenyl ether, monoethylene glycol dimethyl ether, monoethylene glycol diethyl ether, monoethylene glycol dipropyl ether, monoethylene glycol dibutyl ether, monoethylene glycol dipentyl ether, monoethylene glycol dihexyl ether, monoethylene glycol diphenyl ether, and the longer ethylene glycol homologues thereof; monopropylene glycol, monopropylene glycol monomethyl ether, monopropylene glycol monoethyl ether, monopropylene glycol monopropyl ether, monopropylene glycol monobutyl ether, monopropylene glycol monopentyl ether, monopropylene glycol monohexyl ether, monopropylene glycol monophenyl ether, monopropylene glycol dimethyl ether, monopropylene glycol diethyl ether, monopropylene glycol dipropyl ether, monopropylene glycol dibutyl ether, monopropylene glycol dipentyl ether, monopropylene glycol dihexyl ether, monopropylene glycol diphenyl ether, and the longer propylene homologues thereof; monoethylene glycol monomethyl ether acetate, monoethylene glycol diacetate, and the longer ethylene glycol homologues thereof; monopropylene glycol monomethyl ether acetate, monopropylene glycol acetate, and the longer polypropylene glycol homologues thereof;
simple and substituted amines, for example diethylamines, triethylamines, diisopropylamines, diisopropylethylamines, monoethanolamines, diethanolamines, triethanolamines and more highly alkoxylated amines, anilines or dimethylanilines;
amides/ureas, for example N-formylmorpholine, N,N-dimethylformamide, N,N-dimethylacetamide, N,N-dimethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, tetramethylurea, tetraethylurea, 1,3-dimethyl-2-imidazolidinone, 1,3,4-trimethyl-2-imidazolidinone, 1,3-dimethyl-3,4,5,6-tetrahydro-2(1H)-pyrimidinone, 1-heptyl-3-methyl-2-imidazolidinone, 1-heptyl-1,3-dihydro-3-methyl-2H-imidazol-2-one;
ketones, for example acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone or valerophenone;
nitriles, for example acetonitrile, propanenitrile, 2-methylpropanenitrile, butanenitrile, 3-methylbutanenitrile, pentanenitrile, 4-methylpentanenitrile, hexanenitrile, heptanenitrile, octanenitrile, nonanenitrile, decanenitrile, benzonnitrile, benzeneacetonitrile, pentanedinitrile, 2-methylpentanedinitrile, hexanedinitrile, heptanedinitrile, octanedinitrile or nonanedinitrile;
acetals, for example 1,1-dimethoxymethane; 1,1-dimethoxyethane; 1,1′-[methylenebis(oxy)]bisethane; 1,1-diethoxyethane; 1,1′-[methylenebis(oxy)]bispropane; 2,4,6,8-tetraoxanonane, 1,1′-[methylenebis(oxy)]bisbutane, 2-methyl-1-[(2-methylpropoxy)methoxy]propane, 2,4,6,8,10-pentaoxaundecane, 2,5,7,10-tetraoxaundecane, 1,3-dioxolane, 1,3-dioxane or 4-methyl-1,3-dioxane; orthoesters, for example 1,1,1-trimethoxymethane, 1,1,1-trimethoxyethane, 1,1,1-trimethoxypropane, 2-methoxy-1,3-dioxolane, 2-methoxy-2-methyl-1,3-dioxolane, 2-methoxy-2-methyl-1,3-dioxolane, 2-ethoxy-1,3-dioxotane, 2-ethoxy-2-methyl-1,3-dioxolane, 2-ethyl-2-methoxy-1,3-dioxolane, 2-methoxy-1,3-dioxane, 2-methoxy-2-methyl-1,3-dioxane or 2-ethoxy-1,3-dioxane;
carbonates, for example dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one or dibenzyl carbonate;
phosphates, for example trimethyl phosphate, triethyl phosphate, tripropyl phosphate, tributyl phosphate, triisobutyl phosphate, tripentyl phosphate, trihexyl phosphate, tris(2-ethylhexyl) phosphate, tris(2-butoxyethyl) phosphate or triphenyl phosphate;
sulphoxides, for example dimethyl sulphoxide, diethyl sulphoxide, 1,1-dioxotetrahydrothiophene, 1,1-dioxotetrahydro-3-methylthiophene or 1,1-dioxotetrahydro-2,4-dimethylthiophene.

The formulations of the invention may, as well as compound (I), also contain one or more solvents b). The further organic solvent used in the formulations of the invention is preferably N,N-dimethyldecanamide. Likewise preferred are Rhodiasolv® PolarClean or Solvesso®.

The proportion of component b) in the formulations of the invention may be 20% by weight to 95% by weight, preferably 40% by weight to 80% by weight.

The proportion of compound I) in component b) may be 1% by weight to 95% by weight, preferably 5% by weight to 70% by weight, more preferably 15% by weight to 60% by weight.

In a further embodiment, the proportion of compound (I) in component b) may be 100% by weight.

The present invention likewise provides liquid formulations comprising
a) prothioconazole and
b) at least one organic solvent, characterized in that one organic solvent is a compound of the formula (I)

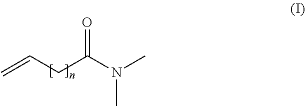

in which
n is 3, 4, 5, 6, 7, 8, 9, 10, 11, 12, 15 or 18,
c) at least one nonionic (c1) emulsifier and
d) one or more further active agrochemical ingredients.

In a further embodiment, the formulation of the invention may comprise a nonionic (c1) and/or anionic (c2) emulsifier.

The formulation of the invention may also comprise further additives, for example cationic emulsifiers, defoamers, thickeners, dispersants, stabilizers, adjuvants, preservatives, polymers, acids and bases, dyes, antifreezes, biocides, fillers and also water. An adjuvant in this context is a component which enhances the biological effect of the formulation, without the component itself having any biological effect. Examples of adjuvants are agents which promote retention, spreading, attachment to the leaf surface or penetration.

The emulsion concentrates of the invention are usually largely anhydrous. “Largely anhydrous” in the sense of the present invention means at most 5% by weight, preferably at most 1% by weight and more preferably at most 0.5% by weight, of water. In a further form, the concentrate contains 0.5% to 4.5% by weight, preferably 0.5% to 2% by weight, more preferably 0.5% to 1% by weight, of water.

Useful nonionic emulsifiers c1) include standard surface-active substances present in formulations of active agrochemical ingredients. Examples include ethoxylated nonylphenols, polyethylene glycol ethers of linear alcohols, end group-capped and non-end group-capped alkoxylated linear and branched, saturated and unsaturated alcohols, reaction products of alkylphenols with ethylene oxide and/or propylene oxide, ethylene oxide-propylene oxide block copolymers, polyethylene glycols and polypropylene glycols, and also fatty acid esters, fatty acid polyglycol ether esters, alkylsulphates, alkylsulphates, arylsulphates, ethoxylated arylalkylphenols, for example tristyrylphenol ethoxylate having an average of 16 ethylene oxide units per molecule, and also ethoxylated and propoxylated arylalkylphenols, and also sulphated and phosphated arylalkylphenol ethoxylates or ethoxy- and propoxylates. Particular preference is given to tristyrylphenol alkoxylates and fatty acid polyglycol ether esters. Very particular preference is given to tristyrylphenol ethoxylates, tristyrylphenol ethoxy propoxylates and castor oil polyglycol ether esters, in each case individually or in mixtures. Additionally useful are additives, such as surfactants or esters of fatty acids, which contribute to improvement in biological efficacy. Suitable nonionic emulsifiers c1) are, for example, Soprophor® 7961P, Lucramul® C030, Lucramul® HOT, Lucramul® PSI 100 or Synperonic® T304.

TABLE 1
Illustrative trade names and CAS numbers
of preferred emulsifiers c1)

| Trade name | Company | General description | CAS No. |
|---|---|---|---|
| Berol ® 827 | Akzo | Castor oil ethoxylate | 26264-06-2 |
| | Nobel | (25EO) | |
| Berol ® 828 | Akzo | Castor oil ethoxylate | 26264-06-2 |
| | Nobel | (15EO) | |
| Berol ® 829 | Akzo | Castor oil ethoxylate | 26264-06-2 |
| | Nobel | (20EO) | |
| Berol ® 192 | Akzo | Castor oil ethoxylate | 26264-06-2 |
| | Nobel | (12EO) | |
| Alkamuls ® A | Solvay | Oleic acid, ethoxylated | 9004-96-0 |
| Arlatone ® T | Croda | Ethoxylated sorbitol | 54846-79-6 |
| | | heptaoleate (40EO) | |
| Emulsogen ® | Clariant | Castor oil ethoxylate | 61791-12-6 |
| EL-400 | | (40EO) | |
| Crovol ® | Croda | Fats and glyceridic oils, | 70377-91-2 |
| CR70G | | vegetable source, | |
| | | ethoxylated | |
| Agnique ® | BASF | Oligomeric | 68515-73-1 |
| PG8107 | | D-glucopyranosedecyl | |
| | | octylglycosides | |
| Tween ® 80 | Croda | Sorbitan monooleate, | 9005-65-6 |
| | | ethoxylated (20EO) | |
| Tween ® 85 | Croda | Sorbitan trioleate, | 9005-70-3 |
| | | ethoxylated (20EO) | |
| Tween ® 20 | Croda | Sorbitan monolaurate, | 9005-64-5 |
| | | ethoxylated (20EO) | |

Suitable anionic emulsifiers c2) are, for example, alkali metal, alkaline earth metal or ammonium salts of sulphonates, sulphates, phosphates, carboxylates and mixtures thereof, for example the salts of alkylsulphonic acids or alkylphosphoric acids and alkylarylsulphonic or alkylarylphosphoric acids, diphenylsulphonates, alpha-olefinsulphonates, lignosulphonates, sulphonates of fatty acids and oils, sulphonates of ethoxylated alkylphenols, sulphonates of alkoxylated arylphenols, sulphonates of condensed naphthalenes, sulphonates of dodecyl- and tridecylbenzenes, sulphonates of naphthalenes and alkylnaphthalenes, sulphosuccinates or sulphosuccinamates. Examples of sulphates are sulphates of fatty acids and oils, of ethoxylated alkylphenols, of alcohols, of ethoxylated alcohols or of fatty acid esters. Examples of phosphates are phosphate esters. Examples of carboxylates are alkyl carboxylates and carboxylated alcohol ethoxylates or alkylphenol ethoxylates. Likewise suitable is the group of anionic emulsifiers of the alkali metal, alkaline earth metal and ammonium salts of the polystyrenesulphonic acids, salts of the polyvinylsulphonic acids, salts of the alkylnaphthalenesulphonic acids, salts of alkylnaphthalenesulphonic acid-formaldehyde condensation products, salts of condensation products of naphthalenesulphonic acid, phenolsulphonic acid and formaldehyde. Examples are Solvesso® 200, calcium dodecylbenzenesulphonate such as Rhodocal® 70/B (Rhodia), Phenylsulfonate CA100 (Clamant GmbH) or isopropylammonium dodecylbenzenesulphonates such as Atlox® 3300B (Uniqema).

The proportion of component c) (c1 and/or c2) in the formulations of the invention may be 2% to 40% by weight, preferably 10% to 35%, more preferably 15% to 30%.

Active agrochemical ingredients d) in the context of the invention are active fungicidal, insecticidal or herbicidal ingredients. Preferably, the formulation of the invention comprises one or more active insecticidal or fungicidal ingredients d), more preferably one or more active fungicidal ingredients d). The active ingredients used are preferably water-insoluble.

Preferred insecticidal components d) are, for example, imidacloprid, nitenpyram, acetamiprid, thiacloprid, thiamethoxam, clothianidin, cyantraniliprole, chlorantraniliprole, flubendiamide, tetraniliprole, cyclaniliprole, spirodiclofen, spiromesifen, spirotetramat, abamectin, acrinathrin, chlorfenapyr, emamectin, ethiprole, fipronil, flonicamid, flupyradifurone, indoxacarb, metaflumizone, methoxyfenozid, milbemycin, pyridaben, pyridalyl, silafluofen, spinosad, sulfoxaflor, triflumuron, the compound from WO-A 2006/089633 as Example I-1-a-4, the compound disclosed in WO-A 2008/067911 as Example I-1-a-4, the compound disclosed in WO 2013/092350 as Example Ib-14, the compound disclosed in WO 2010/51926 as Example Ik-84.

Preferred fungicidal components d) are, for example, bixafen, fenamidone, fenhexamid, fluopicolide, fluopyram, fluoxastrobin, iprovalicarb, isotianil, isopyrazam, pencycuron, penflufen, propineb, tebuconazole, trifloxystrobin, ametoctradin, amisulbrom, azoxystrobin, benthiavalicarb-isopropyl, benzovindiflupyr, boscalid, carbendazim, chlorothanonil, cyazofamid, cyflufenamid, cymoxanil, cyproconazole, difenoconazole, ethaboxam, epoxiconazole, famoxadone, fluazinam, fluquinconazole, flusilazole, flutianil, fluxapyroxad, isopyrazam, kresoxim methyl, mancozeb, mandipropamid, metconazol, pyriofenone, folpet, metaminostrobin, oxathiapiprolin, penthiopyrad, picoxystrobin, probenazole, proquinazid, pydiflumetofen, pyraclostrobin, sedaxane, spiroxamin, tebufloquin, tetraconazole, valiphenalate, zoxamide, ziram, N-(5-chloro-2-isopropylbenzyl)-N-cyclopropyl-3-(difluoromethyl)-5-fluoro-1-methyl-1H-pyrazole-4-carboxamide, N-(5-chloro-2-isopropylbenzyl)-N-cyclopropyl-3-(difluoromethyl)-5-fluoro-1-methyl-1H-pyrazole-4-carboxamide, 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenylmethane-sulfonate, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr).

Particularly preferred fungicidal mixing partners d) for prothioconazole are, for example: tebuconazole, spiroxamin, bixafen, fluoxastrobin, trifloxystrobin, N-(5-chloro-2-isopropylbenzyl)-N-cyclopropyl-3-(difluoromethyl)-5-fluoro-1-methyl-1H-pyrazole-4-carboxamide, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr) and fluopyram.

Very particular preference is given to the mixtures of a) (prothioconazole) with one or more compounds selected from the group of the compounds d):
a)+d) tebuconazole;
a)+d) trifloxystrobin;
a)+d) fluoxastrobin;
a)+d) bixafen;
a)+d) fluopyram
a)+d) spiroxamine;
a)+d) fluoxastrobin+trifloxystrobin;
+d) trifloxystrobin+spiroxamine;
a)+d) bixafen+tebuconazole;
a)+d) bixafen+fluoxastrobin;
a)+d) bixafen+trifloxystrobin;
a)+d) bixafen+spiroxamine;
a)+d) bixafen+fluopyram;
a)+d) tebuconazole+spiroxamine;
a)+d) tebuconazole+fluopyram;
a)+d) N-(5-chloro-2-isopropylbenzyl)-N-cyclopropyl-3-(difluoromethyl)-5-fluoro-1-methyl-1H-pyrazole-4-carboxamide
a)+d) N-(5-chloro-2-isopropylbenzyl)-N-cyclopropyl-3-(difluoromethyl)-5-fluoro-1-methyl-1H-pyrazole-4-carboxamide+tebuconazole
a)+d) N-(5-chloro-2-isopropylbenzyl)-N-cyclopropyl-3-(difluoromethyl)-5-fluoro-1-methyl-1H-pyrazole-4-carboxamide+flupyram
a)+d) bixafen+(3S,6S,7R,8R)-8-benzyl-3-[({3-isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr)

The proportion of component d) in the formulations of the invention may be 1% by weight to 40% by weight, preferably 3% by weight to 35% by weight.

The content of the individual components in the inventive formulations can be varied within a relatively wide range.

In one embodiment, the formulations of the invention comprise

a) 1% by weight to 40% by weight, preferably 4% by weight to 30% by weight, of prothioconazole,
b) 20% by weight to 95% by weight, preferably 40% by weight to 80% by weight, of organic solvents, where the proportion of component I) is 1% by weight to 95% by weight, preferably 5% by weight to 50% by weight (based on component b),
c) 2% by weight to 40% by weight, preferably 10% by weight to 35% by weight, of nonionic emulsifier,
d) 1% by weight to 40% by weight, preferably 3% by weight to 35% by weight, of one or more active agrochemical ingredients.

In a further embodiment, the formulations of the invention comprise

a) 1% by weight to 40% by weight, preferably 4% by weight to 30% by weight, of prothioconazole,
b) 20% by weight to 95% by weight, preferably 40% by weight to 80% by weight, of organic solvents, where the proportion of component I) is 100% by weight (based on component b),
c) 2% by weight to 40% by weight, preferably 10% by weight to 35% by weight, of nonionic emulsifier,
d) 1% by weight to 40% by weight, preferably 3% by weight to 35% by weight, of one or more active agrochemical ingredients.

In addition, the formulations of the invention may optionally comprise liquid fillers e), for example vegetable or mineral oils or esters of vegetable or mineral oils. Suitable vegetable oils e) are all oils which can typically be used in agrochemicals and can be obtained from plants. Examples include sunflower oil, rapeseed oil, olive oil, castor oil, colza oil, corn oil, cottonseed oil, walnut oil, coconut oil and soya oil. Possible esters are, for example, ethylhexyl palmitate, ethylhexyl oleate, ethylhexyl myristate, ethylhexyl caprylate, isopropyl myristate, isopropyl palmitate, methyl oleate, methyl palmitate, ethyl oleate. Preference is given to rapeseed oil methyl ester and ethylhexyl palmitate. Possible mineral oils are Exxsol® D100 and white oils.

TABLE 2
Illustrative trade names and CAS
numbers of preferred compounds e)

| Trade name | Company | General description | CAS No. |
|---|---|---|---|
| Sunflower | | Triglycerides of | 8001-21-6 |
| oil | | different C14-C18 | |
| | | fatty acids, | |
| | | predominantly | |
| | | unsaturated | |
| Rapeseed | | Triglycerides of | 8002-13-9 |
| oil | | different C14-C18 | |
| | | fatty acids, | |
| | | predominantly | |
| | | unsaturated | |
| Corn oil | | Triglycerides of | 8001-30-7 |
| | | different C14-C18 | |
| | | fatty acids, | |
| | | predominantly | |
| | | unsaturated | |
| Soya oil | | Triglycerides of | 8001-22-7 |
| | | different C14-C18 | |
| | | fatty acids, | |
| | | predominantly | |
| | | unsaturated | |
| Rice oil | | Triglycerides of | 68553-81-1 |
| | | different C14-C18 | |
| | | fatty acids, | |
| | | predominantly | |
| | | unsaturated | |
| Radia ® 7129 | Oleon NV, BE | Ethylhexyl palmitate | 29806-73-3 |
| Crodamol ® OP | Croda, UK | | |
| Radia ® 7331 | Oleon NV, BE | Ethylhexyl oleate | 26399-02-0 |
| Radia ® 7128 | Oleon NV, BE | C12/C14 ethylhexyl | 29806-75-5 |
| | | myristate/laurate | |
| Radia ® 7127 | Oleon NV, BE | Ethylhexyl laurate | 20292-08-4 |
| Radia ® 7126 | Oleon NV, BE | C8/10 ethylhexyl | 63321-70-0 |
| | | caprylate/caprate | |
| Estol ® 1514 | Croda | Isopropyl myristate | 110-27-0 |
| Radia ® 7104 | Oleon NV, BE | Caprylic and capric | 73398-61- |
| | | triglycerides, neutral | 5. 65381- |
| | | vegetable oil | 09-1 |
| Radia ® 7732 | Oleon NV, BE | Isopropyl palmitate | 142-91-6 |
| Crodamol ® | Croda, UK | | |
| IPM | | | |
| Radia ® 7060 | Oleon NV, BE | Methyl oleate | 112-62-9 |
| Radia ® 7120 | Oleon NV, BE | Methyl palmitate | 112-39-0 |
| Crodamol ® | Croda | Ethyl oleate | 111-62-6 |
| EO | | | |
| AGNIQUE | Clariant | Rapeseed oil methyl | 67762-38- |
| ME ® 18 RD-F, | BASF | ester | 3. 85586- |
| Edenor ® | | | 25-0 |
| MESU | | | |
| Exxsol ® | Exxon Mobil | Hydrotreating low | 64742-47-8 |
| D100 | | boilers (petroleum) | |
| Solvesso ® | ExxonMobil | Solvent naphtha | 64742-94-5 |
| 200ND | | (petroleum), heavy | |
| | | aromatic, naphthalene- | |
| | | depleted | |
| Kristol ® M14 | Carless | White mineral oil | 8042-47-5 |
| Marcol ® 82 | ExxonMobil | (petroleum), C14-C30 | |
| Ondina ® 917 | Shell | branched and linear | |
| Exxsol ®D130 | ExxonMobil | White mineral oil | 64742-46-7 |
| Banole ® 50 | Total | (petroleum) | |
| Genera ®-12 | Total | White mineral oil | 72623-86-0 |
| | | (petroleum) | |
| Genera ®-9 | Total | White mineral oil | 97862-82-3 |
| | | (petroleum) | |

Further additives f) which may be present in the formulations of the invention are penetrants, wetting agents, spreading agents and/or retention agents. Suitable substances are all of those which can typically be used for this purpose in agrochemicals.

Suitable additives f) are, for example,
ethoxylated branched alcohols (e.g. Genapol® X type) with 2-20 EO units;
ethoxylated branched alcohols with terminal methyl (e.g. Genapol® XM type) with 2-20 EO units;
ethoxylated coconut alcohols (e.g. Genapol® C. types) with 2-20 EO units;
ethoxylated C12/15 alcohols (e.g. Synperonic® A types) with 2-20 EO units;
propoxy-ethoxylated alcohols, branched or linear, e.g. Antarox® B/848, Atlas® G5000, Lucramul® HOT 5902;
propoxy-ethoxylated fatty acids with terminal methyl, e.g. Leofat® 000503M;
organomodified polysiloxanes, e.g. BreakThru® OE444, BreakThru® 5240, Silwett® L77, Silwett® 408;
mono- and diesters of sulphosuccinate sodium salts with branched or linear alcohols having 1-10 carbon atoms;
ethoxylated diacetylenediols (e.g. Surfynol®).

TABLE 3
Illustrative trade names and CAS numbers of preferred compounds f)

| Trade name | Company | General description | CAS No. |
|---|---|---|---|
| Lucramul ® HOT | Levaco | Alcohol ethoxylate-propoxylate | 64366-70-7 |
| 5902 | | (C8-PO8/EO6) | |
| Genapol ® X060 | Clariant | Alcohol ethoxylate (iso-C13- | 9043-30-5 |
| | | EO6) | |
| Genapol ® XM 060 | Clariant | Alcohol ethoxylate (iso-C13- | 345642-79-7 |
| | | EO6/with Me end group) | |
| Triton ® GR 7 ME | Dow | Dioctylsulphosuccinate, sodium | 577-11-7 |
| | | salt | |
| BreakThru ® OE 444 | Evonik | Siloxanes and silicones, cetyl- | 191044-49-2 |
| | Industries | Me, di-Me | |
| BreakThru ® S240 | Evonik | Polyether-modified trisiloxane | 134180-76-0 |
| | Industries | | |
| Silwett ® L77 | Momentive | Polyalkylene oxide-modified | 67674-67-3 |
| | | heptamethyltrisiloxane | |
| Silwett ® 408 | Momentive | Polyalkylene oxide-modified | 67674-67-3 |
| | | heptamethyltrisiloxane | |
| Antarox ® B/848 | Solvay | Oxirane, methyl-, polymer with | 9038-95-3 |
| | | oxirane, monobutyl ether | |
| Atlas ® G5000 | Croda | Oxirane, methyl-, polymer with | 9038-95-3 |
| | | oxirane, monobutyl ether | |
| Leofat ® OC- | Lion | Oxirane, methyl-, polymer with | 181141-31-1 |
| 0503M | Chemical, JP | oxirane, mono-(9Z)-9- | |
| | | octadecenoate, methyl ether, | |
| | | block | |
| Surfynol ® 440 | Air Products | 2,4,7,9-tetramethyldec-5-yne- | 9014-85-1 |
| | | 4,7-diol, ethoxylated | |

Suitable additives g) which may be present in the formulations of the invention are defoamers g1), preservatives g2), antioxidants g3), dyes g4) and inert fillers g5).

Suitable defoamers g1) are all substances which can typically be used for this purpose in agrochemicals. Preference is given to silicone oils, silicone oil formulations, magnesium stearate, phosphinic acids and phosphonic acids. Examples are Silcolapse® 482 from Bluestar Silicones, Silfoam® SC1132 from Wacker [dimethylsiloxanes and -silicones, CAS No. 63148-62-9], SAG 1538 or SAG 1572 from Momentive [dimethylsiloxanes and -silicones, CAS-Nr. 63148-62-9] or Fluowet® PL 80.

Possible preservatives g2) are all substances which can typically be used for this purpose in agrochemicals. Suitable preservatives are, for example, formulations comprising 5-chloro-2-methyl-4-isothiazolin-3-one [CIT; CAS No. 26172-55-4], 2-methyl-4-isothiazolin-3-one [MIT, CAS No. 2682-20-4] or 1,2-benzisothiazol-3(2H)-one [BIT, CAS No. 2634-33-5]. Examples include Preventol® D7 (Lanxess), Kathon® CG/ICP (Rohm & Haas), Acticide® SPX (Thor GmbH) and Proxel® GXL (Arch Chemicals).

Suitable antioxidants g3) are all substances which can typically be used for this purpose in agrochemicals. Preference is given to butylhydroxytoluene [3,5-di-tert-butyl-4-hydroxytoluene, CAS No. 128-37-0] and citric acid.

Possible dyes g4) are all substances which can typically be used for this purpose in agrochemicals. Examples include titanium dioxide, carbon black, zinc oxide, blue pigments, red pigments and Permanent Red FGR.

Suitable inert fillers g5) are all substances which can typically be used for this purpose in agrochemicals and which do not function as thickeners. Preference is given to inorganic particles such as carbonates, silicates and oxides, and also organic substances such as urea-formaldehyde condensates. Examples include kaolin, rutile, silicon dioxide (“finely divided silica”), silica gel and natural and synthetic silicates, and additionally talc.

The formulations of the invention are produced, for example, by mixing components a) to d) with one another in the particular ratios desired. If the active agrochemical ingredient is a solid substance, it is generally used either in crystalline or amorphous form or in the form of a solution in an organic solvent. It is also possible to use a solid active agrochemical ingredient in the form of a melt.

The present invention also relates to a process for producing the liquid formulations of the invention by mixing components a), b), c) and d), and any further additives.

The temperatures can be varied within a particular range in the course of performance of the process. In general, working temperatures are between 0° C. and 80° C., preferably between 10° C. and 60° C.

In the course of performance of the process of the invention, the procedure is generally to first dissolve the active ingredient in the solvent. The further components are then stirred into the resulting solution.

Useful equipment for performance of the process according to the invention is customary equipment which is used for production of agrochemical formulations.

Examples of administration forms include all the processes known as commonly used to the person skilled in the art: spraying, dipping, misting and a number of specific processes for direct treatment below or above ground of whole plants or parts (seed, root, stolons, stem, trunk, leaf), for example trunk injection in the case of trees or stem bandages in the case of perennial plants, and a number of specific indirect application processes.

The respective area- and/or object-based application rate of the crop protection compositions of a wide variety of different formulation types for control of the harmful organisms mentioned here varies very greatly. In general, the application media known to the person skilled in the art to be commonly used for the respective field of use are used in the conventional amounts for this purpose, for example from several hundred liters of water per hectare in the case of standard spraying processes through a few liters of oil per hectare in the case of ‘ultra low volume’ aircraft application down to a few millilitres of a physiological solution in the case of injection processes. The concentrations of the inventive crop protection compositions in the particular application media therefore vary within a wide range and are dependent on the respective field of use. In general, concentrations known to the person skilled in the art to be commonly used for the respective field of use are used. Preferred concentrations are from 0.01% by weight to 99% by weight, more preferably from 0.1% by weight to 90% by weight.

The agrochemical formulations of the invention can be deployed, for example, in the formulation forms customary for liquid preparations, either as such or after prior dilution with water, i.e., for example, as emulsions, suspensions or solutions. Application is effected by customary methods, i.e., for example by spraying, pouring or injecting.

Depending on the nature of the active ingredient possibly present in addition to prothioconazole, the formulations of the invention are useful for controlling a large number of pests and can be used either for treatment of plant crops or else for that of inanimate material and in the household.

“Pests” or “harmful organisms” are understood here to mean all kinds of pests which can be controlled or kept under control with organic crop protection active ingredients, i.e. crop protection agents, especially fungicides and mixtures of fungicides with other crop protection agents. The term “pest” therefore encompasses organisms that are harmful to plants, especially harmful fungi and their spores, but also harmful insects, arachnids, nematodes and harmful plants. The term “control” encompasses both curative treatment, i.e. the treatment of affected plants with a formulation of the invention, and protective treatment, i.e. the treatment of plants for protection from pest infestation.

The present invention thus also relates to the use of the formulations described herein for control of pests, especially plant pests, and to a method of controlling harmful organisms, especially plant-damaging organisms, comprising the contacting of the harmful organisms, their habitat, their hosts, such as plants and seed, and the soil, the area and the environment in which they grow or could grow, but also of materials, plants, seeds, soil, surfaces or spaces which are to be protected from attack or infestation by organisms that are harmful to plants, with an effective amount of the formulations of the invention.

A further aspect of the invention relates to the use of the formulations described herein for protection of plants including seed, especially useful plants, from infestation by harmful organisms, especially harmful fungi. The present invention thus also relates to the use of the formulations for control of plant-damaging organisms, for example harmful fungi, insects, arachnids, nematodes and harmful plants, especially for control of harmful fungi.

The formulations of the invention can be used in crop protection, particularly as foliar, seed-dressing and soil fungicides, in a manner known per se for control of phytopathogenic fungi.

Plants which can be treated with the formulations of the invention include the following: cotton, flax, grapevines, fruit, vegetables, such as Rosaceae sp. (for example pome fruit such as apples and pears, but also stone fruit such as apricots, cherries, almonds and peaches, and berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, organs and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers), Alliaceae sp. (for example leeks, onions), Papilionaceae sp. (for example peas); main crop plants such as Gramineae sp. (for example maize, turfgrass, cereals such as wheat, rye, rice, barley, oats, sorghum/millet and triticale), Asteraceae sp. (for example sunflowers), Brassicaceae sp. (for example white cabbage, red cabbage, broccoli, cauliflower, Brussels sprouts, Pak Choi, kohlrabi, radishes, and rapeseed, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodder beet, chard, beetroot); sugarcane, poppies, olives, coconuts, cocoa, tobacco and useful plants and ornamental plants in gardens and forests; and genetically modified varieties of each of these plants, and the seeds of these plants.

Preference is given to using the formulations of the invention for treatment of wheat, barley, rye, soya, onions, maize and peanuts.

More particularly, it is possible in principle to use the formulations of prothioconazole of the invention to control all harmful fungi diseases which can also be controlled with the known formulations of prothioconazole. Depending on the particular mixing partner present in each case, the plant diseases are, for example, the following plant diseases:

Alternaria species in vegetables, oilseed rape, sugar beet, soya, cereals, cotton, fruit and rice (e.g. A. solani or A. alternata in potatoes and other plants), Aphanomyces species in sugar beet and vegetables, Ascochyta sp. in cotton and rice, Bipalaris and Drechslera species in maize, cereals, rice and turfgrass (e.g. teres in barley, D. tritci-repentis in wheat), Blumeria graminis (powdery mildew) in cereals, Botrytis cinerea (grey mould) in strawberries, vegetables, flowers and grapevines, Botryodiplodia sp. in cotton, Bremia lactucae in lettuce, Cerospora species in maize, soya beans, rice and sugar beet (e.g. C. beticula in sugar beet), Cochliobolus species in maize, cereals, rice (e.g. Cochliobolus sativus in cereals, Cochliobolus miyabeanus in rice), Corynespora sp. in soya beans, cotton and other plants, Colletotrichum species in soya beans, cotton and other plants (e.g. C. acutatum in various plants), Curvularia sp. in cereals and rice, Diplodia sp. in cereals and rice, Exserohilum species in maize, Erysiphe cichoracearum and Sphaerotheca fuliginea in cucurbits, Fusarium and Verticillium species (e.g. V. dahliae) in various plants (e.g. F. graminearum in wheat), Gaeumanomyces graminis in cereals, Gibberella species in cereals and rice (e.g. Gibberella fujikuroi in rice), Grainstaining complex in rice, Helminthosporium species (e.g. H. graminicola) in maize and rice, Macrophomina sp. in soya and cotton, Michrodochium sp. (e.g. M. nivale in cereals), Mycosphaerella species in cereals, bananas and peanuts (M. graminicola in wheat, M. fijiesis in bananas), Phaeoisaripsis sp. in soya beans, Phakopsara sp. (e.g. P. pachyrhizi and P. meibomiae in soya beans), Phoma sp. in soya, Phomopsis species in soya beans, sunflowers and grapevines (P. viticola in grapevines, P. helianthii in sunflowers), Phytophthora infestans in potatoes and tomatoes, Plasmopara viticola in grapevines, Penecilium sp. in soya and cotton, Podosphaera leucotricha in apples, Pseudocercosporella herpotrichoides in cereals, Pseudoperonospora species in hops and cucurbits (e.g. P. cubenis in cucumbers), Puccinia species in cereals, maize and asparagus (P. triticina and P. striformis in wheat, P. asparagi in asparagus), Pyrenophora species in cereals, Pyricularia oryzae, Corticium sasakii, Sarocladium oryzae, S. attenuatum, Entyloma oryzae in rice, Pyricularia grisea in turfgrass and cereals, Pythium spp. in turfgrass, rice, maize, cotton, oilseed rape, sunflowers, sugar beet, vegetables and other plants, Rhizoctonia-species (e.g. R. solani) in cotton, rice, potatoes, turfgrass, maize, oilseed rape, potatoes, sugar beet, vegetables and other plants, Rynchosporium sp. (e.g. R. secalis) in rice and cereals, Sclerotinia species (e.g. S. sclerotiorum) in oilseed rape, sunflowers and other plants, Septoria tritici and Stagonospora nodorum in wheat, Erysiphe (syn. Uncinulanecator) in grapevines, Setospaeria species in maize and turfgrass, Sphacelotheca reilinia in maize, Thievaliopsis species in soya beans and cotton, Tilletia species in cereals, Ustilago species in cereals, maize and sugar beet, and Venturia species (scab) in apples and pears (e.g. V. inaequalis in apples).

The formulations of the invention can be applied in undiluted form or diluted with water. In general, they are diluted with at least one part water, preferably with 10 parts water and more preferably with at least 100 parts water, for example with 1 to 10 000, preferably 10 to 5000 and more preferably with 50 to 24 000 parts water, based on one part of the formulation.

The present invention likewise provides an emulsion obtainable by mixing water with the liquid formulation of the invention. The mixing ratio of water to emulsion concentrate may be in the range from 1000:1 to 1:1, preferably 400:1 to 10:1.

The dilution is achieved by pouring the emulsion concentrates of the invention into the water. For rapid mixing of the concentrate with water, it is customary to use agitation, for example stirring. However, agitation is generally unnecessary. Even though the temperature for the dilution operation is an uncritical factor, dilutions are typically conducted at temperatures in the range from 0° C. to 50° C., especially at 10° C. to 30° C. or at ambient temperature.

The water used for dilution is generally tap water. The water may, however, already contain water-soluble or finely dispersed compounds which are used in crop protection, for instance nutrients, fertilizers or pesticides.

It is possible to add various kinds of oils, wetting agents, adjuvants, fertilizers or micronutrients and further pesticides (e.g. herbicides, insecticides, fungicides, growth regulators, safeners) to the emulsion of the invention in the form of a premix or, if appropriate, not until shortly before use (tank-mix). These compositions may be added to the formulations of the invention in a weight ratio of 1:100 to 100:1, preferably 1:10 to 10:1.

The user will apply the formulation of the invention typically from a pre-dosing system, a backpack sprayer, a spraying tank, a spraying aircraft or an irrigation system; the formulation of the invention is typically diluted to the desired deployment concentration with water, buffer and/or further auxiliaries, which affords the ready-to-use spray liquid or agrochemical composition of the invention. Typically, 20 to 2000 litres, preferably 50 to 400 litres, of the ready-to-use spray liquor are deployed per hectare of useful agricultural area.

The required application rates of the pure active ingredients without formulation aids depend on the intensity of pest infestation, on the development phase of the plants, on the climatic conditions of the site of use and on the application method. In general, the application rate is in the range from 0.001 to 3 kg, preferably from 0.005 to 2 kg, more preferably from 0.01 to 1 kg and most preferably from 50 to 500 g of active ingredient per hectare, active ingredient here meaning prothioconazole plus possible further active ingredients.

The generally diluted formulations of the invention are applied mainly by spraying, especially spraying of the leaves. Application can be conducted by spraying techniques known to those skilled in the art, for example using water as carrier and amounts of spray liquor of about 50 to 1000 litres per hectare, for example from 100 to 200 litres per hectare.

The novel prothioconazole-containing formulations have advantageous properties in respect of the treatment of plants; more particularly, they feature good use properties, high stability and high fungicidal activity.

The invention is illustrated in detail by the examples but is not restricted thereto.

### EXAMPLES

Components Used:

| Trade name | Chemical name | Manufacturer |
|---|---|---|
| Lucramul ® | Nonionic emulsifier, castor oil | Levaco Chemicals, DE |
| CO30 | ethoxylated | |
| Soprophor ® | Nonionic emulsifier, | Solvay |
| 796/P | ethoxylated-propoxylated | |
| | tristyrylphenol | |
| SAG1572 | Aqueous emulsion of | Momentive ® |
| | polydimethylsiloxane | |
| Hallcomid ® | Dimethyldecenamide | Stepan |
| 1025 | | |
| Genagen ® | Dimethyldecanamide | Clariant |
| 4296 | | |
| Agnique ® | Dimethyldecanamide | BASF |
| KE 3308 | | |

### Determination of 2-(1-chlorocyclopropyl)-1-(2-chlorophenyl)-3-(1H-1,2,4-triazol-1-yl)propan-2-ol (Compound III) in Formulations

2-(1-Chlorocyclopropyl)-1-(2-chlorophenyl)-3-(1H-1,2,4-triazol-1-yl)propan-2-ol is separated from the formulation constituents on a reverse phase column using an isocratic eluent. After MS/MS detection, the quantitative evaluation is conducted by comparing the peak areas with those of the reference object, using an external standard.

High-pressure liquid chromatograph: HP 1090

Sample injection: HP 1090 Autoinjector

Mass spectrometer: Quattro I, Fisons

Integration and evaluation: MassLynx from Micromass

### Example 1: Recipe for a Prothioconazole Emulsion Concentrate Formulation

| Component | % wt/wt |
|---|---|
| Prothioconazole | 25.0 |
| Castor oil ethoxylated 30EO (Lucramul ® CO30) | 20.0 |
| Defoamer (Momentive ® SAG1572) | 0.1 |
| Dimethyldecanamide (Genagen ® 4296) | 54.9 |

### Example 2: Recipe for a Prothioconazole Emulsion Concentrate Formulation with Hallcomid® 1025 as a Full Replacement for Genagen® 4296

| Component | % wt/wt |
|---|---|
| Prothioconazole | 25.0 |
| Castor oil ethoxylated 30EO (Lucramul ® CO30) | 20.0 |
| Defoamer (Momentive ® SAG1572) | 0.1 |
| Dimethyldecenamide (Hallcomid ® 1025) | 54.9 |

### Example 3: Recipe for a Prothioconazole Emulsion Concentrate Formulation with Hallcomid® 1025 as a Partial Replacement for Genagen® 4296

| Component | % wt/wt |
|---|---|
| Prothioconazole | 25.0 |
| Castor oil ethoxylated 30EO (Lucramul ® CO30) | 20.0 |
| Defoamer (Momentive ® SAG 1572) | 0.1 |
| Dimethyldecenamide (Hallcomid ® 1025) | 10 |
| Dimethyldecenamide (Genagen ® 4296) | 44.9 |

### Example 4: Recipe for a Prothioconazole Emulsion Concentrate Formulation with Hallcomid® 1025 as a Partial Replacement for Genagen® 4296

| Component | % wt/wt |
|---|---|
| Prothioconazole | 25.0 |
| Castor oil ethoxylated 30EO (Lucramul ® CO30) | 20.0 |
| Defoamer (Momentive ® SAG1572) | 0.1 |
| Dimethyldecenamide (Hallcomid ® 1025) | 20 |
| Dimethyldecanamide (Genagen ® 4296) | 34.9 |

### Example 5: Comparison of Compound (III) Content of the Formulations from Examples 1 to 4

| | Compound (III) | % wt/wt |
|---|---|---|
| | content % wt/wt | Hallcomid ® 1025 |
| PTZ EC 250 | 0.0029 | 0 |
| PTZ EC 250 | 0.0008 | 10 |
| PTZ EC 250 | 0.0007 | 20 |
| PTZ EC 250 | 0.0001 | 54.90 |

In spite of the already very low content of compound (III) in the starting sample, it was possible to reduce the content of compound (III) by 72% on addition of 10% wt/wt of the solvent Hallcomid®, by 76% on addition of 20% wt/wt, and by 97% on addition of 54.9% wt/wt.

### Example 6: Recipe for a Mixed Formulation of PTZ+TBZ EC 80+160

| Component | % wt/wt |
|---|---|
| Prothioconazole | 8.2 |
| Tebuconazole | 16.3 |
| Castor oil ethoxylated 30EO (Lucramul ® CO30) | 7.5 |
| TSP alkoxylate (Soprophor ® 796/P) | 7.5 |
| Defoamer (Momentive ® SAG1572) | 0.1 |
| Dimethyldecanamide (Agnique ® KE3308) | 60.4 |

### Example 7: Recipe for a Mixed Formulation of PTZ+TBZ EC 80+160 with Complete Replacement of Agnique® KE3308 by Hallcomid® 1025

| Component | % wt/wt |
|---|---|
| Prothioconazole | 8.2 |
| Tebuconazole | 16.3 |
| Castor oil ethoxylated 30EO (Lucramul ® CO30) | 7.5 |
| TSP alkoxylate (Soprophor ® 796/P) | 7.5 |
| Defoamer (Momentive ® SAG1572) | 0.1 |
| Dimethyldecenamide (Hallcomid ® 1025) | 60.4 |

### Example 8: Comparison of Compound (III) Content of the Formulations from Examples 6 and 7

| | Compound (III) | % wt/wt |
|---|---|---|
| | content % wt/wt | Hallcomid ® 1025 |
| PTZ + TBZ 80 + 160 | 0.0022 | 0 |
| PTZ + TBZ 80 + 160 | 0.0004 | 60.4 |

Here too, it is clearly apparent that it was possible to reduce the already very low content of compound (III) once again by 82% on addition of 60.4% wt/wt.

### Example 9: Comparison of Compound (III) Content of the Formulations from Examples 1 to 4 after Storage at 54° C. for 2 Weeks

| | Compound (III) | % wt/wt |
|---|---|---|
| | content % wt/wt | Hallcomid ® 1025 |
| PTZ EC 250 | 0.0056 | 0 |
| PTZ EC 250 | 0.0014 | 10 |
| PTZ EC 250 | 0.0010 | 20 |
| PTZ EC 250 | 0.0001 | 54.90 |

The effect is likewise clearly apparent in the course of storage at 54° C. over 2 weeks. There is a reduction in the content of compound (III) by 75% on addition of 10% wt/wt Hallcomid®, by 82% on addition of 20% wt/wt Hallcomid®, and by 98% on addition on 56.9% wt/wt Hallcomid®.

1. Liquid formulation comprising
a) prothioconazole and
b) at least one organic solvent,
wherein one organic solvent is a compound of formula (I) 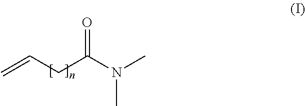
in which
n is 3, 4, 5, 6, 7, 8, 9, 10, 11, 12, 15 or 18.

2. Formulation according to claim 1, wherein, in formula (I), n is 7, 8 or 9.

3. Formulation according to claim 1, wherein the proportion of component b) is 20% by weight to 95% by weight.

4. Formulation according to claim 3, wherein the proportion of compound (I) in component b) is 1% by weight to 95% by weight.

5. Formulation according to claim 3, wherein the proportion of the compound (I) in component b) is 100% by weight.

6. Formulation according to claim 1, characterized in that comprising
c) at least one nonionic (c1) emulsifier and
d) one or more further active agrochemical ingredients.

7. Formulation according to claim 6, comprising a nonionic (c1) and/or anionic (c2) emulsifier.

8. Formulation according to claim 6, wherein said active agrochemical ingredients d) are one or more active insecticidal or fungicidal ingredients.

9. Formulation according to claim 1 comprising
a) 1% by weight to 40% by weight of prothioconazole,
b) 20% by weight to 95% by weight of one or more organic solvents, where the proportion of component I) is 1% by weight to 95% by weight (based on said component b),
c) 2% by weight to 40% by weight of nonionic emulsifier,
d) 1% by weight to 40% by weight of one or more active agrochemical ingredients.

10. Formulation according to claim 1, comprising not more than 5% by weight of water.

11. Process for producing liquid formulation according to claim 6 by mixing said components a), b), c) and d) and the further active agrochemical ingredients.

12. Method of controlling one or more harmful organisms, comprising contacting the harmful organisms, a habitat thereof, a host thereof, optionally plants and/or seed, and/or soil, an area and an environment in which plants grow or could grow, and/or materials, plants, seeds, soil, surfaces and/or spaces which are to be protected from attack or infestation by one or more organisms that are harmful to plants, with an effective amount of the formulation according to claim 1.

13. A product comprising the formulation according to claim 1 for protection of one or more plants including seed, optionally useful plants, from infestation by harmful organisms.

14. A product comprising the formulation according to claim 1 for control of one or more organisms that are harmful to one or more plants, optionally phytopathogenic harmful fungi, insects, arachnids, nematodes and/or harmful plants.

15. A product according to claim 13, wherein the harmful organisms are phytopathogenic harmful fungi.

16. Emulsion obtainable by mixing water with a formulation according to claim 1, wherein the mixing ratio of water to emulsion concentrate may be in the range from 1000:1 to 1:1.
